(19) United States
(12) Patent Application Publication
(10) Pub. No.: US 2026/0238817 A1
(43) Pub. Date: Aug. 13, 2026

(54) COMPRESSION SCHEME FOR POINT CLOUD ATTRIBUTES WITH IMPLICIT INTER-FRAME PREDICTION

(71) Applicant: InterDigital CE Patent Holdings, SAS, Paris (FR)

(72) Inventors: Bertrand CHUPEAU, RENNES (FR); Gustavo SANDRI, CESSON SEVIGNE (FR); Franck THUDOR, RENNES (FR)

(21) Appl. No.: 19/474,939

(22) PCT Filed: Apr. 9, 2024
(86) PCT No.: PCT/EP2024/059528

§ 371 Date: Oct. 13, 2025

(30) Foreign Application Priority Data
Apr. 14, 2023 (EP) 23305564.9

(51) Int. Cl. H04N 19/597; H04N 19/159; H04N 19/17; H04N 19/80

(52) U.S. Cl. CPC H04N 19/597; H04N 19/159; H04N 19/17; H04N 19/80

(57) ABSTRACT

Methods and devices for encoding and decoding a sequence of dense point clouds are disclosed. The encoding consists in obtaining a temporal prediction of the point cloud, compressing it and decompressing it. According to the present principles, the rendering attributes are mapped on the temporal prediction on one side and on the decompressed point cloud on the other side. The first one is subtracted from the second one to obtain a residue that is encoded aside with the compressed geometry. At the decoding, the inverse steps are performed.

### 1. TECHNICAL FIELD

The present principles generally relate to the domain of compression of a point cloud comprising attribute data. The present document is also understood in the context of the encoding, the formatting and the decoding of data representative of a point cloud for example for a rendering of volumetric content on end-user devices such as mobile devices or Head-Mounted Displays (HMD). In particular, the present document relates to a compression scheme for point cloud attributes with implicit inter-frame prediction.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Advances in 3D (three-dimensional) capturing and rendering technologies are enabling new applications and services in the fields of autonomous driving, cultural heritage archival, immersive telepresence and virtual/augmented reality. Point clouds have arisen as one of the main 3D scene representations for such applications. A point cloud frame consists of a set of 3D points, each point being represented by its 3D position and possibly several rendering attributes such as color, transparency, reflectance, normal vector, etc. Points clouds may be dynamic. A sequence of temporally successive points clouds is captured. Each point cloud is then a frame of the sequence and is rendered according to a timestamp within the sequence. The compression of dynamic point clouds is a technical challenge as the amount of data is huge. A combination of tools may be used to perform the compression of a sequence of point clouds, for example a combination of octree+triangle soups for geometry coding, motion compensated inter-frame prediction of geometry (octree and triangle soup), context-adaptive arithmetic coding of octree and triangle soup, and Region-Adaptive Hierarchical Transform (RAHT) for intra-frame colour coding.

A point cloud encoding scheme combining such tools leverages the spatial (intra-frame) and temporal (inter-frame) redundancies for geometry compression. For rendering attributes, however, intra-frame redundancies only are removed. A solution that adds a temporal prediction of colour attributes, from previously encoded point cloud frame, taking into account the motion in between two successive point cloud frames, to reach better compression rates has recently been proposed. However, such a compression scheme achieves high performance at the expense of encoder complexity. Indeed, all prediction modes have to be computed and their performance are measured at each node, and the bitrate to signal to the decoder the selected prediction modes increases with the depth of the octree representing the 3D point cloud. So, there is a lack for a solution that embodies a lightweight compression scheme for compression point cloud attributes, still leveraging the temporal redundancy, but without the requirement of computing, selecting and signalling various prediction modes.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method for encoding, in a data stream, a sequence of point clouds. A point cloud of the sequence comprises a geometry and rendering attributes. The method comprises, for a current frame, obtaining a temporal prediction of current point cloud by motion-compensating the geometry and the rendering attributes of a previous decoded point cloud of the sequence. Then, compressing the geometry of current point cloud, encoding the compressed geometry in the data stream and obtaining a reconstructed point cloud by decompressing the compressed geometry. At this step a double transfer is operated. A mapped current point cloud is obtained by mapping the rendering attributes of the current point cloud on the geometry of the reconstructed point cloud and a mapped temporal prediction is obtained by mapping the rendering attributes of the temporal prediction on the geometry of the reconstructed point cloud. Then, a residue point cloud is obtained by subtracting the attributes of mapped temporal prediction from the attributes of the mapped current point cloud. The resulting rendering attributes of the residue point cloud is intra-frame encoded in the data stream. In an embodiment; a low-pass filtering is applied to the rendering attributes of the mapped temporal prediction.

The present principles also relate to a device comprising a memory associated with a processor configured for implementing the method above.

The present principles also relate to a method for decoding a sequence of point clouds, a point cloud of the sequence comprising a geometry and rendering attributes. The method comprises decoding a compressed geometry from the data stream and obtaining a reconstructed point cloud by decompressing the compressed geometry. A temporal prediction of reconstructed point cloud is obtained by motion-compensating the geometry and the rendering attributes of a previous decoded point cloud of the sequence. A mapped temporal prediction is obtained by mapping the rendering attributes of the temporal prediction on the geometry of the reconstructed point cloud. Then, an intra-frame decoding rendering attributes obtained from the data stream is performed and the attributes of the reconstructed point cloud are set by adding the decoded rendering attributes to the attributes of the temporal prediction. In an embodiment, a low-pass filtering is applied to the rendering attributes of the mapped temporal prediction.

The present principles also relate to a device comprising a memory associated with a processor configured for implementing the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 diagrammatically illustrates a point cloud attribute encoding scheme according to the present principles;

FIG. 2 depicts a decoder scheme corresponding to the encoding scheme of FIG. 1, according to the present principles;

FIG. 3 shows an example architecture of a device which may be configured to implement a method for encoding or decoding a point cloud according to the present principles;

FIG. 4 shows an example of an embodiment of the syntax of a stream when the data are transmitted over a packet-based transmission protocol;

FIG. 5 diagrammatically depicts a two-speed encoder for point cloud attributes according to the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

In a compression scheme of dense point cloud sequences, it is usual to compress the point cloud geometry (the 3D coordinates of the points) first, prior to rendering attributes. At the encoder side, a rendering attribute transfer (also called “recolouring”) is then performed to assign the colours of original point to the points of the decoded geometry. Indeed, in case of lossy geometry compression, the positions of original points may be displaced in the decoded point cloud. Then, rendering attributes are encoded on top of the decoded geometry, independently from the geometry encoding method. At decoder side, the geometry is first decoded and, the reconstructed geometry is available for rendering attributes decoded in a second step.

The present principles describe a compression scheme of compression/decompression scheme for the attributes of a dynamic point cloud, with motion-compensated inter-frame prediction combined with intra-frame prediction, associated with a hierarchical transform.

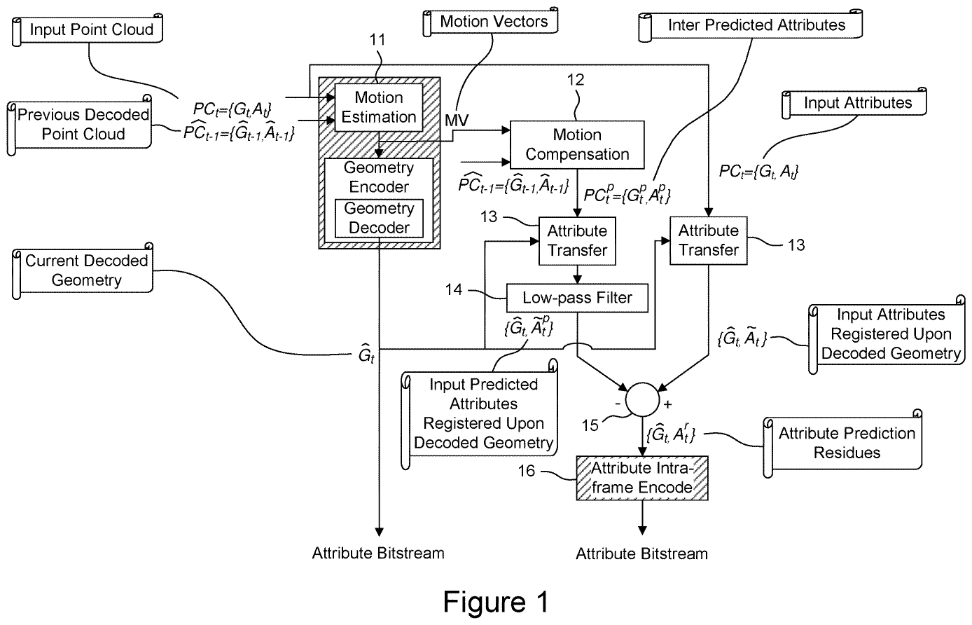

FIG. 1 diagrammatically illustrates a point cloud attribute encoding scheme according to the present principles. A 3D motion estimation 11 is performed between two successive point cloud of a sequence of point clouds (called point cloud frames): the current target frame PCt to encode and a previously decoded reference frame PCt-1. Any motion estimation algorithm may be used for the present method. It only assumes a block-based output motion format, providing a motion vector for each occupied cube (or ‘node’ in an octree-based representation) of the target point cloud frame, pointing to the matched location in the reference point cloud frame. A geometry encoder compresses the geometry. The compressed geometry is encoded in the data stream. Then, the compressed geometry is decompressed to obtain a reconstructed geometry. The geometry encoder takes advantage of 3D motion estimation to remove temporal redundancies and achieve best geometry compression rate. In case of lossy compression, the reconstructed geometry is different from the input geometry.

A motion-compensated inter-frame prediction of attributes of target point cloud frame is performed by module 12: points of decoded geometry Ĝₜ₋₁ are displaced in the direction of the estimated motion vectors, and the corresponding decoded attributes in Âₜ₋₁ make the temporal prediction of current frame attributes

$${A}_{t}^{p} ,$$

which is mapped onto the temporal prediction of geometry

$${G}_{t}^{p} .$$

Then, an attribute transfer processing block 13 registers the input attributes as well as the attributes of the inter-frame prediction onto the points of the current decoded geometry Ĝₜ. A low-pass intra-frame filtering is performed by a module 14 over the temporal point cloud prediction, to remove noise and outliers. Residual attributes (also called a residue) are computed by subtracting temporally predicted attributes

$${\tilde{A}}_{t}^{p}$$

to input attributes Ãₜ, both after their registration upon decoded geometry (attribute transfer) at a step 15 of the present method. Then, the residual attributes are compressed with an intra-frame attribute encoder, consisting of transform (e.g. RAHT), quantization and arithmetic encoding of transformed coefficients by module 16. The modules perform steps of the present method.

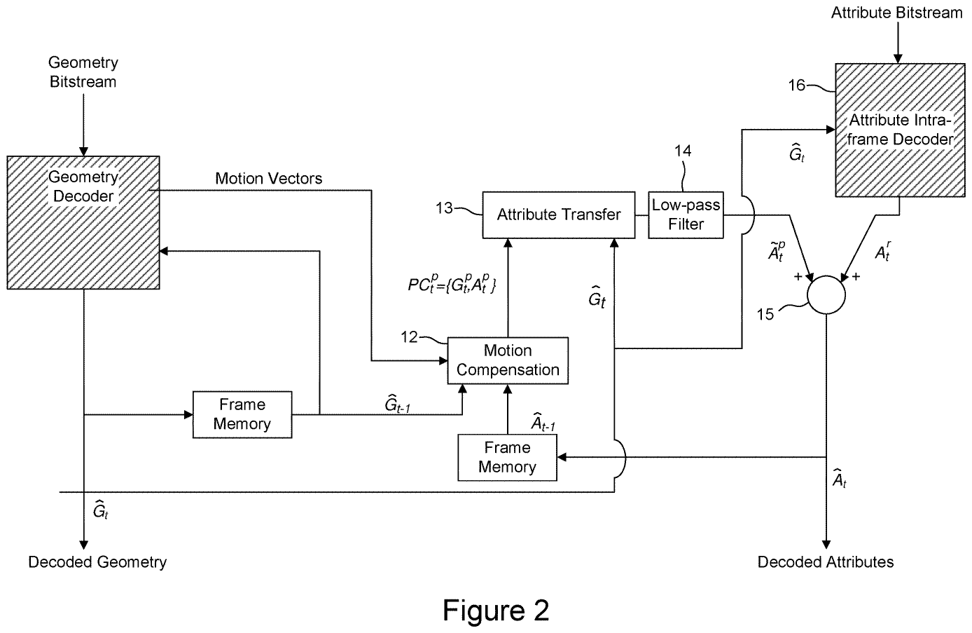

FIG. 2 depicts a decoder scheme corresponding to the encoding scheme of FIG. 1, according to the present principles. The same modules are used.

In the encoding method and in the decoding method according to the present principles, prior to being subtracted to the attributes of the current input frame, the attributes of the temporal point cloud prediction are low-pass filtered by module 14, to remove noise and outlier attribute values. Such a low-pass filtering over the attributes of a point cloud is performed in two steps. First, the point cloud is divided into non overlapping 3D-blocks of fixed size N×N×N, with N equals to 4 or 8 or 10 for example. Second, all occupied voxels (i.e. voxels containing at least one point) in a block are assigned the same attribute values A, which is the average of the attribute values in neighbouring blocks, weighted by the number of point in each such block. For example, the weights of a block are W₁ for the block itself, W₂ for the 6 neighbours sharing a face with the block and W₃ for the 12 neighbours sharing an edge, yielding the equation Eq1.

$$A = \frac{{W}_{1} \times {\sum }_{i = 1}^{{N}_{1}} {a}_{1 , i} + {W}_{2} \times {\sum }_{k = 1}^{6} {\sum }_{i = 1}^{{N}_{2}^{k}} {a}_{2 , i}^{k} + {W}_{3} \times {\sum }_{k = 1}^{12} {\sum }_{i = 1}^{{N}_{3}^{k}} {a}_{3 , i}^{k}}{{W}_{1} \times {N}_{1} + {W}_{2} \times {\sum }_{k = 1}^{6} {N}_{2}^{k} + {W}_{3} \times {\sum }_{k = 1}^{12} {N}_{3}^{k}} \qquad Eq1$$

where N₁ is the number of point in the central block, W₁ the weight of the contribution of central cube cube, a_{1,i} the attribute of the i-th point in this cube;

$${N}_{2}^{k}$$

the number of points in the k-th block sharing a face, W₂ the weight of the contributions of the neighbours sharing a face

$${a}_{2 , i}^{k}$$

the attribute value of the i-th point of the k-th block sharing a face; and the same for the 12 blocks sharing an edge. For example, W₁=4, W₂=2, W₃=1.

In an embodiment, the attribute transform performed by module 16 is the RAHT transform, as implemented within the MPEG G-PCC encoder, in which a transform domain prediction has been added to the basic RAHT transform, generating high-pass residuals that can be further quantized and entropically encoded. This prediction is obtained by averaging predictions coming from already decoded nodes at lower resolution or in a causal decoding neighbourhood at the same resolution level. Such intra-frame prediction is able to capture inter-layer and intra-layer redundancies by averaging predictions coming from already decoded nodes at lower resolution or in a causal decoding neighbourhood at the same resolution level. When input with the temporal prediction residual according to the present principles, both temporal and spatial redundancies are leveraged.

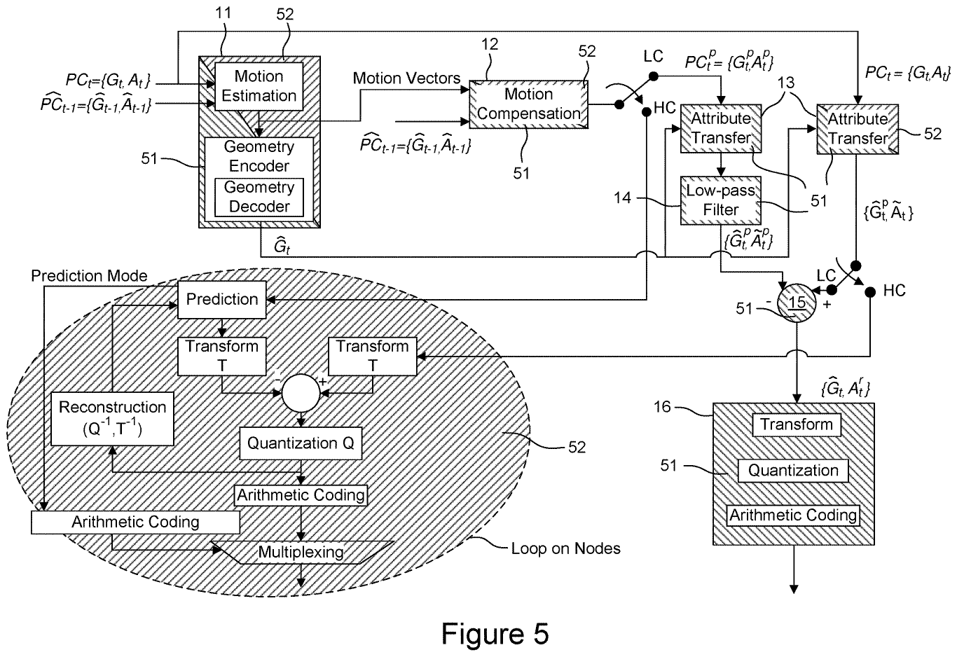

FIG. 5 diagrammatically depicts a two-speed encoder for point cloud attributes according to the present principles. A low complexity (LC) path 51 and a high-complexity (HC) path 52 are represented. Some processing blocks are common to both paths. The present scheme is targeting in particular low bit rate operating points, where the explicit signalling of prediction modes is no longer negligible compared with the overall bit-rate, and where the coarse quantization makes the input residual attributes easier to encode. Simulation results indeed show competitive performance at low bit-rates, compared with either “all intra” (that is with no temporal prediction) or more complex intra/inter hybrid schemes with prediction mode signalling. At middle to high bit-rates, the input temporal prediction residual becomes more difficult to encode and the performance decreases, however. Also, for those sequences where the motion compensation provides an estimated point cloud very similar to the current point cloud, especially in the case of low movement sequences, the method according to the present principles provides competitive performances even for high bit rates.

So, a two-speed encoding scheme, with the a low-complexity encoder embedded within a more complex hybrid encoder is set up according to the present principles, as illustrated in FIG. 5. The low-complexity encoding workflow is activated depending on the encoder target bit-rate or on the input sequence characteristics, and the decision is signalled to the decoder in the data stream.

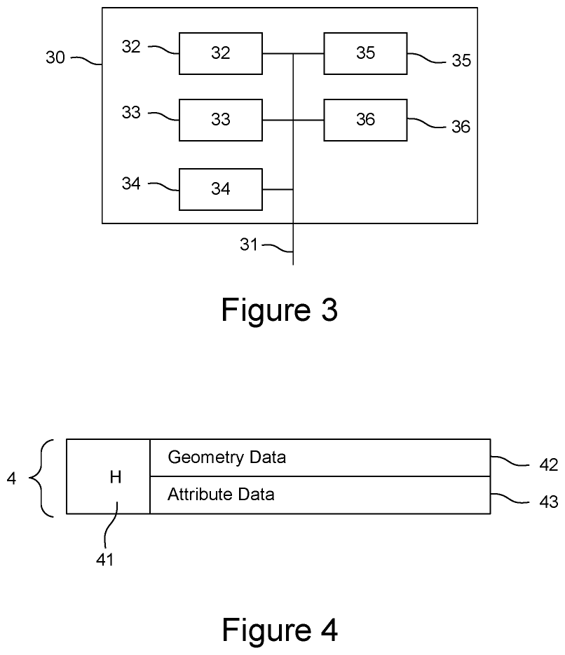

FIG. 3 shows an example architecture of a device 30 which may be configured to implement a method for encoding or decoding a sequence of point clouds according to the present principles. An encoder may implement the method described in relation to FIG. 1 and a decoder may implement the method described in relation to FIG. 2. Alternatively, each circuit of the encoder and/or the decoder may be a device according to the architecture of FIG. 3, linked together, for instance, via their bus 31 and/or via I/O interface 36. Device 30 comprises following elements that are linked together by data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 belongs to a set comprising:
a mobile device;
a communication device;
a game device;
a tablet (or tablet computer);
a laptop;
a still picture camera;
a video camera;
an encoding chip;
a server (e.g. a broadcast server, a video-on-demand server or a web server).

FIG. 4 shows an example of an embodiment of the syntax of a stream when the data are transmitted over a packet-based transmission protocol. FIG. 4 shows an example structure 4 of a stream encoding a sequence of point clouds according to the present principle. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure comprises a payload comprising an element of syntax 42 and at least one element of syntax 43 (there may be an element of syntax 43 for each type of attribute data, for instance one for the color, one for the reflectance, one for the normal vectors, etc.). Syntax element 42 comprises data representative of the geometry of the point cloud, that is a series of bits representative of the octree. Element of syntax 43 is a part of the payload of the data stream and may comprise data encoding the attribute values as represented in the point cloud or as residual data (called residue) for a prediction step.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for encoding, in a data stream, a sequence of point clouds, a point cloud of the sequence comprising a geometry and rendering attributes, the method comprising, for a current frame:
obtaining a temporal prediction of a current point cloud by motion-compensating the geometry and the rendering attributes of a previously decoded point cloud of the sequence;
compressing the geometry of the current point cloud, encoding the compressed geometry in the data stream and obtaining a reconstructed point cloud by decompressing the compressed geometry;
obtaining a mapped current point cloud by mapping the rendering attributes of the current point cloud on the geometry of the reconstructed point cloud;
obtaining a mapped temporal prediction by mapping the rendering attributes of the temporal prediction on the geometry of the reconstructed point cloud and by low-pass filtering the rendering attributes of the mapped temporal prediction;
obtaining a residue point cloud by subtracting the rendering attributes of the mapped temporal prediction from the rendering attributes of the mapped current point cloud; and
intra-frame encoding the rendering attributes of the residue point cloud in the data stream.

2. (canceled)

3. The method of claim 1, further comprising encoding data in the data stream indicating that the method of claim 1 is used.

4. A device for encoding, in a data stream, a sequence of point clouds, a point cloud of the sequence comprising a geometry and rendering attributes, the device comprising a processor associated with a memory, the processor being configured for:
obtaining a temporal prediction of a current point cloud by motion-compensating the geometry and the rendering attributes of a previously decoded point cloud of the sequence;
compressing the geometry of the current point cloud, encoding the compressed geometry in the data stream and obtaining a reconstructed point cloud by decompressing the compressed geometry;
obtaining a mapped current point cloud by mapping the rendering attributes of the current point cloud on the geometry of the reconstructed point cloud;
obtaining a mapped temporal prediction by mapping the rendering attributes of the temporal prediction on the geometry of the reconstructed point cloud and by low-pass filtering the rendering attributes of the mapped temporal prediction;
obtaining a residue point cloud by subtracting the rendering attributes of the mapped temporal prediction from the attributes of the mapped current point cloud; and
intra-frame encoding the rendering attributes of the residue point cloud in the data stream.

5. (canceled)

6. The device of claim 4, wherein the processor is further configured for encoding data in the data stream indicating that the method of claim 1 is used.

7. A method for decoding a sequence of point clouds, a point cloud of the sequence comprising a geometry and rendering attributes, the method comprising:
decoding a compressed geometry from a data stream and obtaining a reconstructed point cloud by decompressing the compressed geometry;
obtaining a temporal prediction of the reconstructed point cloud by motion-compensating the geometry and the rendering attributes of a previously decoded point cloud of the sequence;
obtaining a mapped temporal prediction by mapping the rendering attributes of the temporal prediction on the geometry of the reconstructed point cloud and by low-pass filtering the rendering attributes of the mapped temporal prediction;
intra-frame decoding rendering attributes obtained from the data stream; and
setting the attributes of the reconstructed point cloud by adding the decoded rendering attributes to the attributes of the temporal prediction.

8. (canceled)

9. The method of claim 7, comprising obtaining data from the data stream indicating whether the method of claim 1 has been used and if so, applying the decoding method of claim 7, otherwise applying a method indicated by the data.

10. A device for decoding a sequence of point clouds, a point cloud of the sequence comprising a geometry and rendering attributes, the device comprising a processor associated with a memory, the processor being configured for:
decoding a compressed geometry from a data stream and obtaining a reconstructed point cloud by decompressing the compressed geometry;
obtaining a temporal prediction of a reconstructed point cloud by motion-compensating the geometry and the rendering attributes of a previously decoded point cloud of the sequence;
obtaining a mapped temporal prediction by mapping the rendering attributes of the temporal prediction on the geometry of the reconstructed point cloud and by low-pass filtering the rendering attributes of the mapped temporal prediction;
intra-frame decoding rendering attributes obtained from the data stream; and
setting the rendering attributes of the reconstructed point cloud by adding the decoded rendering attributes to the attributes of the temporal prediction.

11. (canceled)

12. The device of claim 10, wherein the processor is configured for first obtaining data from the data stream indicating whether the method of claim 1 has been used and if so, applying the method of claim 7, otherwise applying a method indicated by the data.
